(19) United States
(12) Patent Application Publication
(10) Pub. No.: US 2011/0318944 A1
(43) Pub. Date: Dec. 29, 2011

(54) Probe Connector

(76) Inventors: Ming-Han Lin, Taipei (TW); Chih-Heng Chien, Taipei (TW)

(21) Appl. No.: 12/825,327

(22) Filed: Jun. 28, 2010

(51) Int. Cl. H01R 13/24; H01R 12/16

(52) U.S. Cl. 439/83; 439/700

(57) ABSTRACT

A probe connector has a base. The base has a plurality of through inserting holes at a front surface thereof. A rear surface of the base has a plurality of fixing slots, each of which extends at a side of the inserting hole and communicates with the corresponding inserting hole. A probe pin assembly has a barrel received in the inserting hole, an elastic element, and a plunger. An outer peripheral surface of the barrel is formed with a fixing recess. A conduct element has a base plate attached to a bottom surface of the base and a locking plate extended from the base plate and attached to the rear surface. The locking plate has at least one locking opening, corresponding to the inserting hole, and two opposite sides extended forwards to form two fixing slices received in the fixing slots, with free ends thereof buckled in the fixing recess.

### BACKGROUND OF THE INVENTION

1. Field of the Invention

The present invention relates to a probe connector, and particularly to a probe connector connected to a PCB.

2. The Related Art

A conventional probe connector, which is used to transmit the electrical signals for electronic devices, is generally involved with an insulating housing, and a plurality of probe pin assemblies mounted to the insulating housing. The probe pin assembly includes a barrel mounted in a through hole of the insulating housing, with a bottom thereof connected to a printed circuit board (PCB), a spring received in the barrel, and a plunger. The plunger has one end restrained in the barrel and pressing against the spring, and the other end extending out of the barrel. Herein, the barrel is plated with gold for improving contacting efficiency between the plunger and an inner surface of the barrel and the conductibility of the barrel. Conventionally, a contact portion of an electronic device presses the exposed end of the plunger to make the plunger deflect and contact the inner surface of the barrel, thereby achieving electrical connection. However, as the spring is compressed under the action of the pressed plunger, an elastic force generated by the spring is applied to the bottom of the barrel, which is liable to force the barrel to move outwards with respect to the insulating housing, even released from the insulating housing. As a result, the conducting quality of the probe connector decreases, it may even break off.

### SUMMARY OF THE INVENTION

Accordingly, an object of the present invention is to provide a probe connector connected to a PCB. The probe connector includes an insulating housing having a rectangular base, a plurality of probe pin assemblies, and a conduct element. The base defines a front surface, a rear surface and a bottom surface connecting with the front surface and the rear surface. The front surface has a plurality of inserting holes, arranged side by side. The inserting holes extend rearwards to reach the rear surface. The rear surface has a plurality of fixing slots. The fixing slot extends at a side of the inserting hole in a direction perpendicular to the bottom surface and communicates with the corresponding inserting hole. The probe pin assembly has a barrel received in the inserting hole, an elastic element accommodated in the barrel, and a plunger having one end restrained in the barrel and the other end extending out of the barrel. An outer peripheral surface of the barrel has a portion formed with a fixing recess. The conduct element has a base plate attached to the bottom surface. A rear edge of the base plate extends perpendicularly to form a locking plate attached to the rear surface. The locking plate has at least one locking opening, corresponding to the inserting hole for allowing the barrel to pass therethrough. Two opposite sides of the locking plate are extended forwards to form a pair of fixing slices received in the fixing slots, with free ends thereof buckled in the fixing recess of the inserted barrel for fixing the probe pin assembly to the insulating housing.

As described above, the conduct element is fixed in the insulating housing. The free ends of the fixing slices are buckled in the fixing recess of the inserted probe pin assembly. The conduct element is simple and convenient to manufacture and assemble. Furthermore, such structure of the conduct element is excellent to fix the barrel in the insulating housing firmly, preventing the probe pin assembly from moving with respect to the insulating housing in long-term use, and keep the signal conducting stability of the probe connector.

### BRIEF DESCRIPTION OF THE DRAWINGS

The present invention will be apparent to those skilled in the art by reading the following description thereof, with reference to the attached drawings, in which:

FIG. 1 is an assembled, perspective view of a probe connector of an embodiment in accordance with the present invention, wherein a printed circuit board is disposed under the probe connector;

FIG. 2 is an assembled, perspective view of the probe connector of FIG. 1 seen from a bottom angle;

FIG. 3 is an exploded, perspective view of the probe connector shown in FIG. 2; and

FIG. 4 is an assembled, perspective view of the probe connector of FIG. 3, wherein an insulating housing is removed.

### DETAILED DESCRIPTION OF THE EMBODIMENT

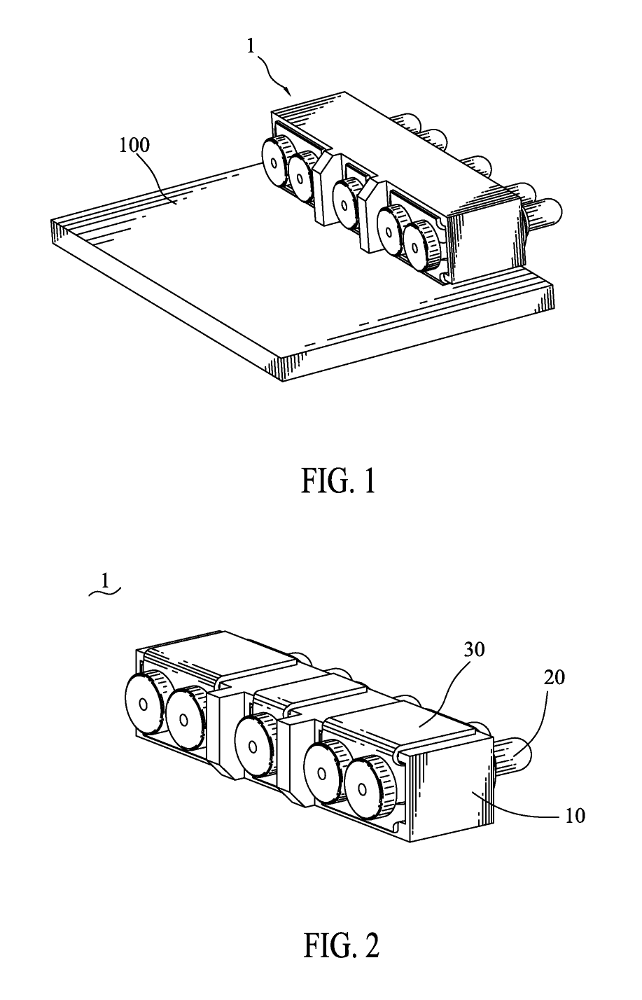

Referring to the drawings in greater detail, and first to FIGS. 1-3, the embodiment of the present invention is embodied in a probe connector 1. The probe connector 1 includes an insulating housing 10, a plurality of probe pin assemblies 20 mounted to the insulating housing 10, and a plurality of conduct elements 30 for electrically connecting the probe pin assemblies 20 with a printed circuit board (PCB) 100. The insulating housing 10 has a substantially rectangular base 11. The base 11 defines a front surface 111, a rear surface 112, and a bottom surface 113 connecting with the front surface 111 and the rear surface 112. The front surface 111 has a plurality of columned inserting holes 12 for receiving the probe pin assemblies 20. The inserting holes 12 are arranged side by side and extend rearward to reach the rear surface 112. In this embodiment, there are five inserting holes. The rear surface 112 has a plurality of fixing slots 150 extending upwards and downwards. Each of the fixing slots 150 is located at a side of the inserting hole 12 and has an opening communicating with the corresponding inserting hole 12. In this embodiment, there are two fixing slots disposed at two opposite sides of the middle inserting hole, and there are two fixing slots disposed at outer sides of the two adjacent inserting holes.

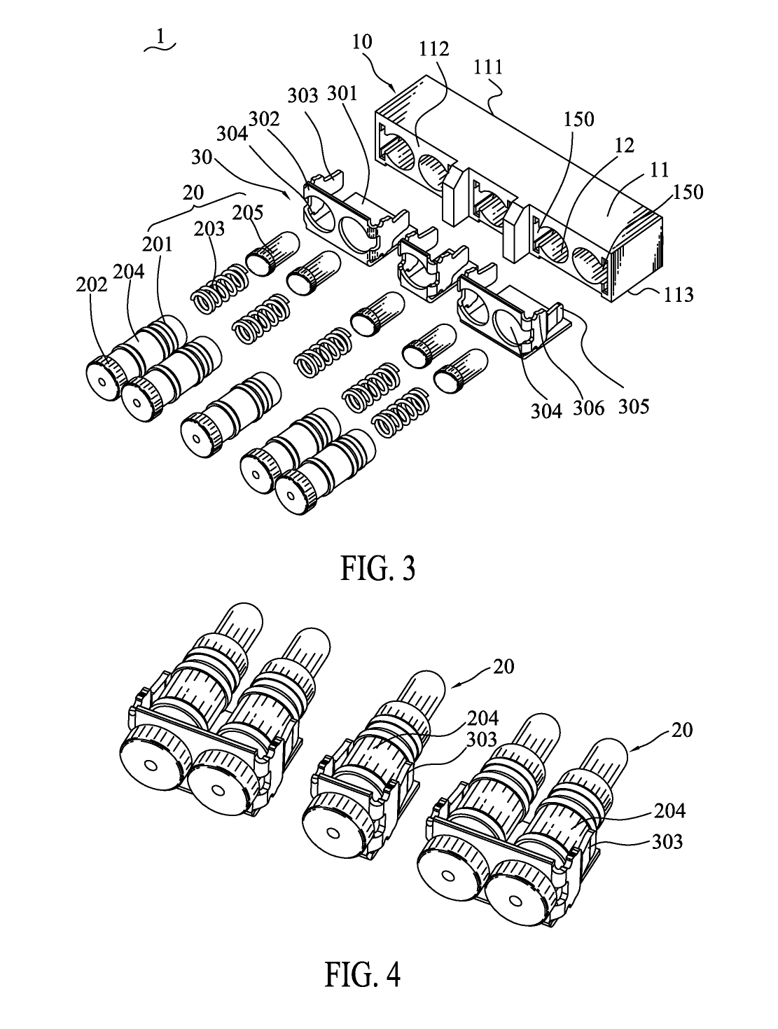

Please refer to FIG. 3 and FIG. 4, the probe pin assembly 20 includes a hollow barrel 201, a plunger 205 and an elastic element 203 received in the barrel 201. The barrel 201 and the plunger 205 are made of metallic material. The barrel 201 is cylindraceous and has a stopping plate 202 integrally sealed a rear end thereof for being against a rear end of the received elastic element 203. The stopping plate 202 has a diameter larger than that of the barrel 201. An outer peripheral surface of the barrel 201 is depressed inwards to form a fixing recess 204 at a substantially middle portion thereof. The fixing recess 204 extends around the barrel 201 to a show a ring shape. It should be noted that the shape of the fixing recess can be changed for meeting different demands and should not be limited. For example, the outer peripheral surface of the barrel is formed with two fixing recesses symmetrically. The plunger 205 has a rear end restrained in the barrel 201 and resting against a front end of the elastic element 203, and a front end extending out of the barrel 201 for electrically contacting an electronic device (not shown). Herein, the elastic element 203 is a spring.

Referring to FIGS. 2-4, the conduct element 30 has a rectangular base plate 301, a locking plate 302 extended upwards from a rear edge of the base plate 301. The base plate 301 is attached to the bottom surface 113. Herein, the bottom surface 113 is formed with an indention area for receiving the base plate 301. The locking plate 302 is substantially rectangular, and has at least one locking opening 304 for engaging with the probe pin assembly 20 received in the inserting hole 12. The locking plate 302 has two opposite sides extended forwards to form fixing slices 303, corresponding to the fixing slots 150. Free ends of the facing fixing slices 303 are deflected toward each other to form locking portions 305, corresponding to the fixing recess 204. A top side of each fixing slice 303 is protruded upwards to form barbs 306, adjacent to the locking plate 302, for interfering with a side of the fixing slot 150 to fix the conduct element 30 to the insulating housing 10. In this embodiment, there are three conduct elements. One of the conduct elements has one locking opening at the locking plate thereof for holding the barrel received in the middle inserting hole, and each of other conduct elements has two abreast locking openings at the locking plate thereof for holding the two barrels received in the two adjacent inserting holes.

With reference to FIGS. 1-2 and FIG. 4, in assembly, the conduct elements 30 are mounted to the insulating housing 10. The probe pin assembly 20 passes through the locking opening 304 and is inserted into the inserting hole 12 in a rear-to-front direction, until the stopping plate 202 rests against the locking plate 302. The locking portions 305 are buckled in the fixing recess 204 for preventing the probe pin assembly 20 from moving rearwards. The plunger 205 extends out of the front surface 111 of the insulating housing 10. The bottom surface 113 of the probe connector 1 is attached to the PCB 100. The base plate 301 is soldered onto the PCB 100. It should be noted that the assembling process can be changed for meeting different demands and should not be limited.

As described above, the conduct element 30 is fixed in the insulating housing 10. The base plate 301 of the conduct element 30 is soldered onto the PCB 100. The locking portions 305 are buckled in the fixing recess 204 of the inserted probe pin assembly 20. The conduct element 30 is simple and convenient to manufacture and assemble. Furthermore, such structure of the conduct element 30 is excellent to fix the barrel 201 in the insulating housing 10 firmly, preventing the probe pin assembly 20 from moving with respect to the insulating housing 10 in long-term use, and keep the signal conducting stability of the probe connector 1.

What is claimed is:

1. A probe connector connected to a PCB, comprising:
an insulating housing having a rectangular base, the base defining a front surface, a rear surface and a bottom surface connecting with the front surface and the rear surface, the front surface having a plurality of inserting holes, arranged side by side, the inserting holes extending rearwards to reach the rear surface, the rear surface having a plurality of fixing slots, the fixing slot extending at a side of the inserting hole in a direction perpendicular to the bottom surface and communicating with the corresponding inserting hole;
a plurality of probe pin assemblies, the probe pin assembly having a barrel received in the inserting hole, an elastic element accommodated in the barrel, and a plunger having one end restrained in the barrel and the other end extending out of the barrel, an outer peripheral surface of the barrel having a portion formed with a fixing recess; and
a conduct element having a base plate attached to the bottom surface, a rear edge of the base plate extending perpendicularly to form a locking plate attached to the rear surface, the locking plate having at least one locking opening, corresponding to the inserting hole for allowing the barrel to pass therethrough, two opposite sides of the locking plate extended forwards to form a pair of fixing slices received in the fixing slots, with free ends thereof buckled in the fixing recess of the inserted barrel for fixing the probe pin assembly to the insulating housing.

2. The probe connector as claimed in claim 1, wherein the free ends of the fixing slices are deflected toward each other for inserting into the fixing recess.

3. The probe connector as claimed in claim 1, wherein there are two fixing slots located at outer sides of two adjacent inserting holes for receiving the fixing slices, the locking plate has two locking openings, corresponding to the inserting holes.

4. The probe connector as claimed in claim 1, wherein there are two fixing slots disposed at two opposite sides of the inserting hole, the locking plate has one locking opening, corresponding to the inserting hole.

5. The probe connector as claimed in claim 1, wherein the bottom surface of the insulating housing is attached to the PCB, the base plate is sandwiched between the insulating housing and the PCB for being soldered to the PCB.

6. The probe connector as claimed in claim 1, wherein the barrel is cylindraceous and has a stopping plate sealed a rear end thereof for being against a rear end of the elastic element, the stopping plate has a diameter larger than that of the barrel for resting against the locking plate when the barrel passes through the locking opening in a rear-to-front direction.

7. The probe connector as claimed in claim 1, wherein a side of the fixing slice is protruded outwards to form a plurality of barbs for buckling with an inner side of the fixing slot to fix the conduct element to the insulating housing.

8. The probe connector as claimed in claim 1, wherein the fixing recess extends around the barrel to a show a ring shape.
